(19) United States
(12) Patent Application Publication
(10) Pub. No.: US 2011/0283558 A1
(43) Pub. Date: Nov. 24, 2011

(54) LAUNDRY DRYING APPLIANCE COMPRISING A PROCESS AIR CIRCUIT AND A SENSOR PLACED THEREIN

(75) Inventors: Huilong Feng, Nanjing (CN); Wenfeng Pang, Nanjing (CN); Zhihua Yan, Nanjing (CN)

(73) Assignee: BSH BOSCH UND SIEMENS HAUSGERÄTE GMBH, Munich (DE)

(21) Appl. No.: 13/130,765

(22) PCT Filed: Nov. 9, 2009
(86) PCT No.: PCT/EP2009/064840

§ 371 Date: Aug. 10, 2011

(30) Foreign Application Priority Data
Nov. 25, 2008 (CN) 200820215209.X

(51) Int. Cl. F26B 19/00

(52) U.S. Cl. 34/549

(57) ABSTRACT

A household laundry drying appliance includes a process air circuit in which process air is circulated to remove moisture contained in laundry; and a sensor placed in the process air circuit. The sensor has a head portion for detecting a predetermined parameter of the process air and a base portion for assembly. The head portion is encapsulated in a protecting structure. With the protection of the protecting structure, The head portion can be protected from water splashing thereon, and as a result, the accuracy of the sensor is effectively maintained and the evaluation of the dryness of laundry taken in consideration of the detecting value of the sensor becomes reliable.

The present invention relates to a household laundry drying appliance comprising a process air circuit in which process air is circulated to remove the moisture contained in laundry, and a sensor placed in said process air circuit, said sensor having a head portion for detecting a predetermined parameter of the process air and a base portion for assembly.

The drying of laundry via the application of heated air in a conventional laundry drying appliance or laundry washing and drying appliance is well known in the prior art. Such conventional appliance typically comprises a perforated drum rotatably mounted for receiving the laundry to be dried, a heating device for heating process air to an appropriate temperature to remove the moisture from the laundry, a blower for forcing the circulation of the process air, and a condensation device for condensing the moisture conveyed in the process air. In a simple drying appliance, the drum may be closed in itself except for some inlet and outlet to pass the process air through. In a washing and drying appliance, the drum may have many perforations for passing suds for washing laundry as well as process air for drying, and may be placed in a tub which is closed in itself except for suitable inlets and outlets for suds and process air, to contain the suds used for washing.

When the appliance is in operation, the process air is heated by said heating device to a temperature regulated by a temperature sensor configured adjacent to said heating device, then the process air is forced into said drum to be mixed with the laundry loaded therein. After the exchange of heat and moisture between the process air and the laundry, moisture from the laundry is absorbed into the process air, which is discharged into said condensation device where the moisture conveyed into said process air is condensed into water; the water will then be pumped out or stored in a suitable container for later disposal. The process air having passed through said condensation device may again be routed into the heating device via said blower. As a consequence of such re-circulation of the process air, the moisture contained in the laundry is removed and the laundry becomes gradually dried, and the moisture withdrawn from the laundry is recovered in the heat exchanger for disposal.

To precisely control the dryness of the laundry and prevent over-drying which could damage the laundry, a temperature sensor or a NTC sensor is further incorporated into the process air circuit for detecting the temperature or another parameter of the process air, possibly after heat exchanging with the laundry and before entering into said condensation device. The value of the temperature or other parameter of the process air is then employed in the evaluation of the dryness of the laundry.

As an example, EP 1 838 917 B1 discloses a method for monitoring a NTC resistor to measure the temperature of an air flow which is used for drying clothes. However, since the temperature sensor or the NTC sensor is normally configured near to the entrance to the condensation device, some liquid unavoidably conveyed into the process air at the condensation device (for example, water drops formed in the condensation device or withdrawn from residual liquid in the tub, in the case of a washing and drying appliance) will exert an undesirable influence on the accuracy of the sensor, which consequently influences the evaluation of the dryness of the laundry.

It is accordingly an object of the present invention to provide a household laundry drying appliance that overcomes the hereinbefore-mentioned disadvantages of the heretofore-known household appliances of this general type and that ensures proper evaluation of the dryness of the laundry being processed.

According to the present invention, there is provided a household laundry drying appliance comprises a process air circuit in which process air is circulated to remove the moisture contained in laundry; and a sensor placed in said process air circuit, said sensor having a head portion for detecting a predetermined parameter of the process air and a base portion for assembly; wherein said head portion is encapsulated in a protecting structure.

With the protection by the protecting structure, said head portion is be protected from water or other liquid splashing thereon, and as a result, the accuracy of the sensor can be effectively maintained and the evaluation of the dryness of laundry taken in consideration of the detecting value of the sensor becomes reliable.

As a preferred embodiment of the present invention, said protecting structure is in the shape of a cylinder, which is accordingly proportional to the shape of said head portion of said sensor so as to substantially cover the circumference of said head portion.

As another preferred embodiment of the present invention, said protecting structure includes an opening end and an opposite closing end. Said closing end faces the flow of said process air, therefore even if there are some liquids or water conveyed in the process air flow, no water can enter into inside of said protecting structure to get in touch with said head portion.

According to a further preferred embodiment of the present invention, a plurality of elongated frames longitudinally extends along the circumference of said protecting structure to maintain an appropriate space between said protecting structure and said head portion of the sensor and prevent the whole structure from deforming caused by the process air flow.

As an advantageous aspect of the said further preferred embodiment of the present invention, a mesh is interpolated between said plurality of frames for preventing water or any other liquids from splashing against the head portion of the sensor while allowing the process air to flow through so as to maintain the reliability of the sensor.

As another advantageous aspect of the said further preferred embodiment of the present invention, the aperture of said mesh has a diameter of 200 μm to 400 μm. So water is kept out while the process air can go through said mesh.

According to a yet another preferred embodiment of the present invention, said protecting structure has an axially symmetrical cross section and a plurality of fins extend substantially tangentially to the circumference of said protecting structure. So water is kept out by said plurality of fins while the process air can flow through the opening formed between said plurality of fins. Therefore the accuracy of said sensor is well maintained.

As an advantageous aspect of the said yet another preferred embodiment of the present invention, to make certain that no water goes through the openings between said plurality of fins, each of said plurality of fins overlaps with the adjacent fin.

As still another preferred embodiment of the present invention, at least two opposite clips extend inwardly from said opening end, a flange portion further extends from said base portion to couple to said clips. As a result, such a simple configuration makes the assembly of the protecting structure and the sensor simplified.

As yet a further preferred embodiment of the present invention, for positioning the protecting structure in regard to the head portion of the sensor, a protrusion extends from said base portion to partially surround said head portion, wherein said opening end is retained on said protrusion when assembled.

As still a further preferred embodiment of the present invention, said sensor is a temperature sensor assembly for detecting the temperature of the process air flow.

Furthermore, as another preferred embodiment of the present invention, said sensor is a NTC thermostat assembly, which can be used for detecting the temperature or other parameters of the process air flow.

By way of illustration only, preferred embodiments of the present invention are described more fully hereinafter with reference to the figures of the accompanying drawing, wherein:

FIG. 1 is a diagrammatic cross-sectional view of a laundry drying appliance;

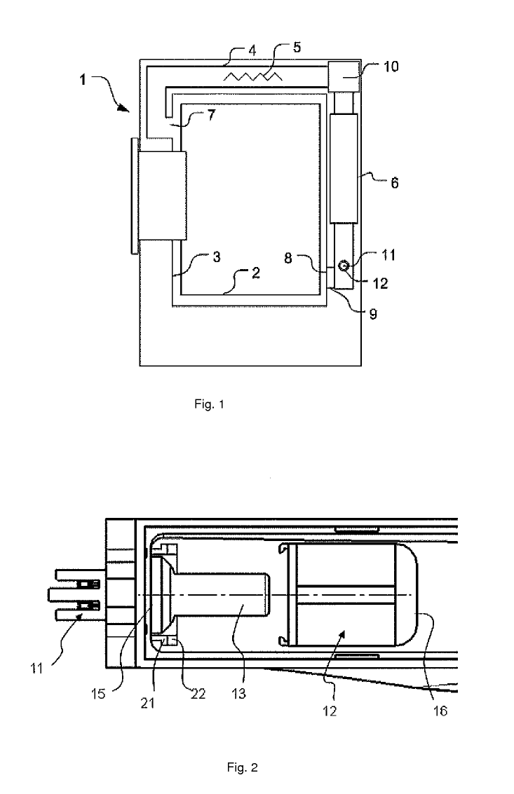

FIG. 2 is a perspective view of a protecting structure disassembled with a sensor;

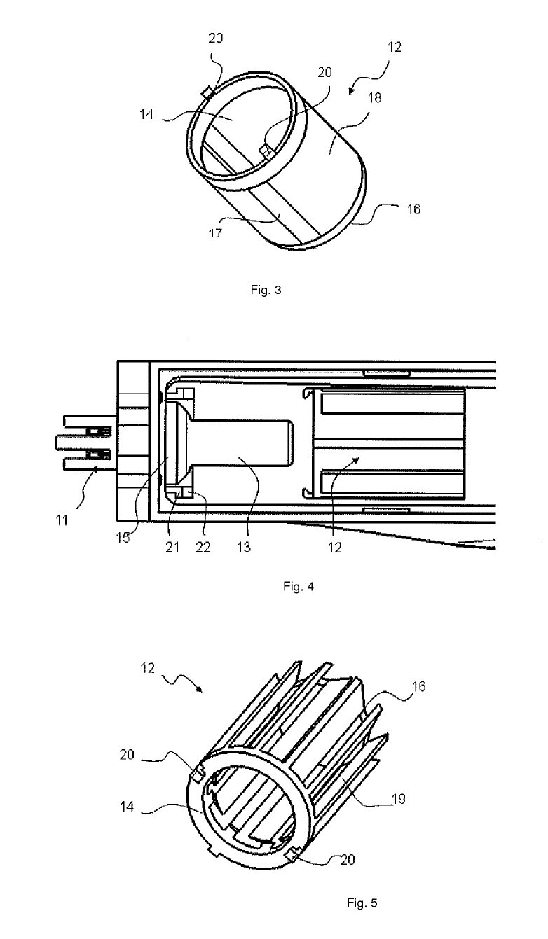

FIG. 3 is a perspective view of the protecting structure as shown in FIG. 2;

FIG. 4 is a perspective view of a protecting structure disassembled with a sensor; and

FIG. 5 is a perspective view of the protecting structure as shown in FIG. 4.

Referring now to FIG. 1, there is schematically shown a household laundry drying appliance 1, having a rotatably mounted drum 2 for receiving the laundry to be washed and/or dried. The drum 2 is perforated and is housed in a tub 3 which in its turn contains suds and other liquids used for washing and rinsing the laundry. To dry the laundry, a process air is circulated for removing the moisture contained in the laundry. Furthermore, a heating tunnel 4, in which a heating device 5 is provided for heating the process air, is preferably configured on top of said tub 3 and a condensation device 6 is preferably configured on rear of said tub 3. One end of said heating tunnel 4 is connected to an air inlet 7 defined on said tub 3 and one end of said condensation device 6 is connected to an air outlet 8 on said tub 3 opposite to said air inlet 7. The other end of said heating tunnel 4 is connected to the other end of said condensation device 6. In such a way, a process air circuit 4, 6, 10 is formed in said heating tunnel 4 together with said tub 3, said drum 2 and said condensation device 6. A nozzle 9 or other type of connecting structure may be employed for connecting said heating tunnel 4 to said air inlet 7, and connecting said condensation device 6 to said air outlet 8 to absorb the oscillation caused by the high speed rotation of the drum 2 when the laundry drying appliance is in operation. To force the circulation of the process air, a blower 10 is further provided between said condensation device 6 and said heating device 5. When the drying process is initiated, the process air is heated by the heating device 5 and supplied into the drum 2 to contact the laundry loaded inside. With the movement of the process air flow, the process air is mixed with the laundry and the moisture contained in the laundry is absorbed by the process air. Through said air outlet 8 on the tub, the process air is discharged into said condensation device 6, where the condensation is processed. Either water or air or the combination of water and air can be applied as the condensing medium, so the moisture conveyed in the process air is condensed into water. The water together with the condensing water where is applicable will then be pumped out or stored for later disposal by known measures. The process air is returned into said heating tunnel 4 by the blower 10 and heated again by the heating device 5 to be re-circulated.

To monitor the temperature or other parameter of the process air flowing, a temperature sensor or NTC sensor 11 encapsulated in a protecting structure 12 according to the present invention is configured at the entrance to said condensation device 6. Alternatively the sensor 11 can be installed between said condensation device 6 and said air outlet 8 of the tub 3, to be exact, in said nozzle 9.

Now referring to FIGS. 2 and 3, a first preferred embodiment is shown. Said temperature sensor or NTC sensor 11 includes a head portion 13 which is applied for detecting the temperature or other parameters of the process air flow, and a base portion 15 for assembly. Accordingly, said protecting structure 12 has a shape of substantially cylinder with an opening end 14 and an opposite closing end 16. A plurality of elongated frames 17 are formed between said opening end 14 and said closing end 16, and a mesh 18 is attached between said frames 17 to prevent the water or water drops from splashing against the heat portion 13 of the temperature sensor or the NTC sensor 11. Said mesh 18 has an aperture in an appropriate diameter so that the mesh 18 can keep the water or water drops out of the head portion 13 while the process air can still flow through. Preferably the aperture has a diameter of 200 μm to 400 μm. Of course, the aperture may obviously be in other different shape, regular or irregular.

FIGS. 4 and 5 show a second preferred embodiment. Accordingly the protecting structure 12 of the second preferred embodiment has a shape of cylinder similar to the protection structure of the first preferred embodiment; it also has an opening end 14 and an opposite closing end 16; while there are some differences as follows. Instead of the mesh 18 attached between the frames 17, the protecting structure 12 of the second preferred embodiment has a plurality of fins 19 extending outwardly from the circumference of the protecting structure 12, and said plurality of fins 19 are approximately tangential to the circumference. Preferably the cross section of the protecting structure 12 of the second preferred embodiment is symmetric in regard to a vertical axis. So the water conveyed by the process air flow discharged from the outlet of the tub or the water drops falling from said condensation device 6 can be prevented from splashing against the head portion 13 of the temperature sensor or NTC sensor 11 by said plurality of fins 19, while the process air can still flow smoothly through the openings formed between adjacent fins 19.

Now referring to FIGS. 2 to 5, at least two clips 20 extend inwardly from the opening end 14 of said protecting structure 12, and accordingly a flange portion 21 formed on said base portion 15 of the temperature sensor or NTC sensor 11. Also at a lower position of said base portion 15, a protrusion 22 is defined on a side of said base portion 15 same to said head portion 13. When assembled, said clips 20 are coupled to said flange portion 21 while said opening end 14 is retained on said protrusion 22.

In such a configuration, the head portion 13 of the temperature sensor or NTC sensor 11 is encapsulated in said protecting structure 12, no water or water drops is expected to splash against said head portion 13, therefore the accuracy of the sensor 11 is improved and the dryness of laundry is ensured accordingly.

Although the present invention has been herein shown and described in what is conceived to be the most practical and preferred embodiments, it is recognized that departures can be made within the scope of the present invention, which is not to be limited to the details described herein but is to be accorded with the full scope of the appended claims so as to embrace any and all equivalent devices and apparatus.

1-12. (canceled)

13. A household laundry drying appliance, comprising:
a process air circuit in which process air is circulated to remove moisture contained in laundry;
a sensor which is a temperature sensor assembly and placed in the process air circuit, said sensor having a head portion for detecting a temperature of the process air and a base portion for assembly; and
a protecting structure encapsulating the head portion of the sensor.

14. The appliance of claim 13, wherein the protecting structure is in the shape of a cylinder.

15. The appliance of claim 13, wherein the protecting structure includes an opening end and an opposite closing end.

16. The appliance of claim 13, further comprising a plurality of elongated frames longitudinally extending along a circumference of the protecting structure.

17. The appliance of claim 16, further comprising a mesh attached between the plurality of frames.

18. The appliance of claim 17, wherein the mash has an aperture between 200 μm to 400 μm.

19. The appliance of claim 16, wherein the protecting structure has an axially symmetrical cross section and a plurality of fins which extend substantially tangentially to the circumference of the protecting structure.

20. The appliance of claim 19, wherein the plurality of fins are arranged in overlapping relationship.

21. The appliance of claim 15, wherein the base portion has a flange portion, and further comprising at least two opposite clips extending inwardly from the opening end and coupled to the flange portion of the base portion.

22. The appliance of claim 21, wherein the base portion has a protrusion to partially surround the head portion, said opening end being retained on the protrusion when assembled.

23. The appliance of claim 13, wherein the sensor is a NTC thermostat assembly.
